(19) United States
(12) Patent Application Publication
(10) Pub. No.: US 2025/0286847 A1
(43) Pub. Date: Sep. 11, 2025

(54) AUTOMATED SLANG, SYNONYM AND MISTRANSCRIPTION DETECTION APPARATUSES, METHODS AND SYSTEMS

(71) Applicant: LEO Technologies, LLC, Austin, TX (US)

(72) Inventors: Aslam Karamath Tajwala, Irvine, CA (US); Timothy Ray Anderson, Foothill Rach, CA (US); James McAbee Sexton, Los Angeles, CA (US)

(21) Appl. No.: 18/601,918

(22) Filed: Mar. 11, 2024

(51) Int. Cl. H04L 51/21; G06F 40/247; G06F 40/284

(52) U.S. Cl. CPC H04L 51/21; G06F 40/247; G06F 40/284

(57) ABSTRACT

The AUTOMATED SLANG, SYNONYM AND MISTRANSCRIPTION DETECTION APPARATUSES, METHODS AND SYSTEMS (“SSMD”) provides a platform that, in various embodiments, is configurable to train and/or employ one or more machine learning models utilizing word embeddings representations to analyze transcriptions of communications, such as those of incarcerated individuals. Such models may suggest synonyms, slang, mistranscriptions, and/or misspellings to users performing searches within communications records, such as call transcripts, thereby enhancing the speed, efficacy, accuracy, and/or precision associated with such searches.

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### FIELD

The present inventions are directed generally to apparatuses, methods, and systems for efficient data collection, storage, and evaluation, and more particularly, to AUTOMATED SLANG, SYNONYM AND MISTRANSCRIPTION DETECTION APPARATUSES, METHODS AND SYSTEMS (“SSMD”).

### BACKGROUND

Ubiquitous electronic communications have resulted in large volumes of information being generated and stored. Modern computing technologies facilitate the collection and processing of such large amounts of data, such as to facilitate searching or other analysis.

### SUMMARY

“Word embeddings” are a type of word representation that provides for a similar representation of different words that have similar meanings. They may allow, for example, the representation of language using high-dimensional vectors, facilitating the use of algebraic operations to analyze words, such as based on their semantic meaning.

Embodiments of the SSMD include the training and/or employment of one or more machine learning models utilizing word embeddings representations to analyze transcriptions of communications, such as those of incarcerated individuals, inmates, and/or the like. Such models may suggest synonyms, slang, mistranscriptions, misspellings, and/or the like to users performing searches within communications records, such as call transcripts, thereby enhancing the speed, efficacy, accuracy, precision, and/or the like associated with such searches. Embodiments of the SSMD may, in various implementations, be integrated into existing inmate communication analysis systems to enhance search capabilities, providing significant utility for law enforcement, legal professionals, correctional facility staff, and/or the like.

In one embodiment, the SSMD may further include a processor-implemented method, comprising: integrating an inmate communications language model with at least one inmate communications search application via a model application programming interface; and providing real-time lexicographic recommendations in response to at least one inmate communications search query, the real-time lexicographic recommendations comprising at least one of a synonym, slang term, mistranscription correction, and misspelling correction.

In another embodiment, the SSMD may further include an apparatus, comprising: a processor; a memory communicatively coupled to the processor and storing program instructions that, when executed, cause the processor to: integrate an inmate communications language model with at least one inmate communications search application via a model application programming interface; and provide real-time lexicographic recommendations in response to at least one inmate communications search query, the real-time lexicographic recommendations comprising at least one of a synonym, slang term, mistranscription correction, and misspelling correction.

In another embodiment, the SSMD may further include a processor-accessible, non-transitory medium storing processor-issuable program instructions, comprising: integrate an inmate communications language model with at least one inmate communications search application via a model application programming interface; and provide real-time lexicographic recommendations in response to at least one inmate communications search query, the real-time lexicographic recommendations comprising at least one of a synonym, slang term, mistranscription correction, and misspelling correction.

In another embodiment, the SSMD may further include a processor-implemented method, comprising: receiving inmate communications data; transcribing the inmate communications data to yield a plurality of inmate communication transcripts; tokenizing the plurality of inmate communication transcripts to yield a plurality of inmate communications tokens; removing stop words from the plurality of inmate communications tokens; performing word embeddings to map the plurality of inmate communications tokens to a corresponding plurality of inmate communications vectors; splitting the plurality of inmate communications vectors into training vectors and testing vectors; selecting a language model architecture for an inmate communications language model; training the inmate communications language model with the training vectors; validating the inmate communications language model with the testing vectors; integrating the inmate communications language model with at least one inmate communications search application via a model application programming interface; providing real-time lexicographic recommendations in response to at least one inmate communications search query, the real-time lexicographic recommendations comprising at least one of a synonym, slang term, mistranscription correction, and misspelling correction; receiving recommendation feedback in response to the real-time lexicographic recommendations; and updating at least one inmate communications language model parameter based on the recommendation feedback.

### BRIEF DESCRIPTION OF THE DRAWINGS

The accompanying appendices and/or drawings illustrate various non-limiting, example, inventive aspects in accordance with the present disclosure:

FIG. 1 shows an implementation of logic flow for overall operation in some embodiments of the SSMD;

FIG. 2 shows an implementation of logic flow for transcript preparation and processing in some embodiments of the SSMD;

FIG. 3 shows an implementation of logic flow for SSMD model training in some embodiments of the SSMD;

FIG. 4 shows an implementation of logic flow for application integration of an SSMD model in some embodiments of the SSMD;

FIG. 5 shows an implementation of user interface for assisted search in some embodiments of the SSMD;

FIG. 6 shows another implementation of user interface for assisted search in some embodiments of the SSMD;

FIGS. 7A-7B show an implementation of word embedding search results in some embodiments of the SSMD; and

FIG. 8 shows a block diagram illustrating embodiments of a SSMD controller.

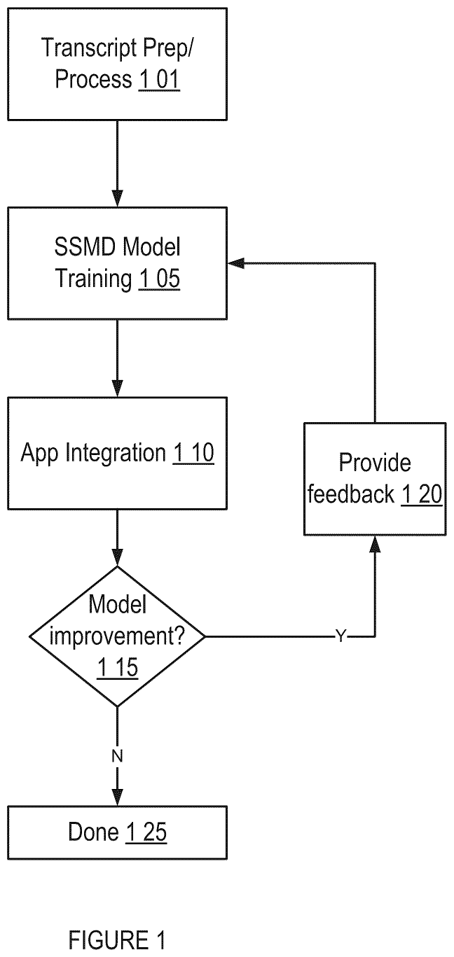

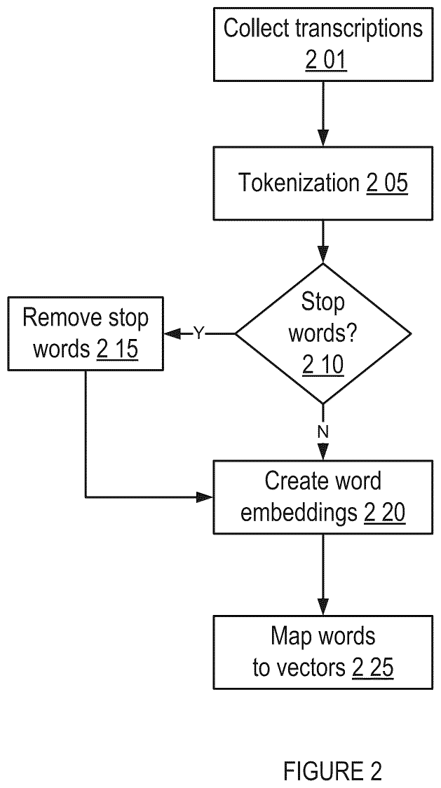

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Automated Slang, Synonym and Mistranscription Detection (SSMD)

The AUTOMATED SLANG, SYNONYM AND MISTRANSCRIPTION DETECTION APPARATUSES, METHODS AND SYSTEMS (hereinafter “SSMD”) provides a platform that, in various embodiments, is configurable to facilitate the provision of more accurate search results by comprehending context and semantics of communications, such as those of inmates in an incarceration setting.

### Context-Understanding Capabilities

Communications, such as those of inmates, may involve the use of creative or coded language to conceal meaning, such as potentially illicit activities, posing a challenge for conventional search and analysis systems which may miss such covert references. Embodiments of the SSMD address these issues, leveraging machine learning to understand the context in which words and phrases are used.

For example, an inmate might refer to a “drone,” a device often used for smuggling contraband into prisons, as a “mosquito,” based on the shared attributes of flight, buzzing sound, and/or the like. In another example may be the association between the words “machete” and “lawnmower blade,” referring to improvised weapons made from lawnmower blades inside a prison facility.

Implementations of the SSMD machine learning model, trained on extensive inmate communication data, may be configured to recognize the semantic connection between such usages based on the usage context. In other words, the model does not merely match words but rather effectuates an automated understanding of the underlying meaning and context. This can allow, for example, for the deciphering of coded language, revelation of hidden implications and connections, and provision of a deeper and more comprehensive understanding of inmate communications. Such context awareness significantly enhances the capability to detect concealed discussions and activities, rendering a valuable tool, e.g., for law enforcement, prison authorities, and/or the like.

### Mistranscription/Misspelling Detection

Embodiments of the SSMD may further include the ability to detect mistranscriptions and/or misspellings. Transcriptions of communications, such as inmate phone calls, may be imperfect, such as due to variations in speech, background noise, use of slang or colloquial language, and/or the like. This can result in words being misinterpreted and/or mistranscribed. For example, the term “covid” could be erroneously transcribed as “covet.”

Implementations of the SSMD address such issues by utilizing word embedding similarity scores in conjunction with a phonetic distance measure. The combination facilitates the detection and suggestion of potential mistranscriptions. Thus, when a user performs a search, an SSMD system may not only provide results based on lexical matches but may also consider the semantic and phonetic similarity between the searched term and terms in its database. So, for example, even if “covid” were mistakenly transcribed as “covet,” a search for “covid” would still highlight instances of “covet” as a potential mistranscription based on the semantic context in which it's used and the phonetic similarity to the input term.

This feature significantly enhances the accuracy and completeness of search results, such as by accounting for potential errors in transcription, rendering a valuable tool for parsing through and making sense of large volumes of inmate communications data.

### Operational Processes

The operational process of the SSMD is illustrated, in one embodiment, in FIGS. 1-4. As shown in FIG. 1, the SSMD may include preparation and processing of inmate communication transcriptions 101, including by transforming them into word-embedding representations. This may, for example, include tokenization of the transcripts into individual words and/or phrases, which may then be mapped to multi-dimensional vectors. By mapping words and/or phrases into vectors, an SSMD model facilitates the understanding of context and semantic similarities among words and phrases in inmate communications (e.g., according to one or more distance metrics within the vector space).

After creating the vector representations, the SSMD machine learning model is trained on this data 105. Once trained, the SSMD model can take an input word and/or phrase and return similar results, such as but not limited to synonyms, slang words, mistranscriptions, misspellings, similar sounding words, and/or the like, thereby enhancing the accuracy and/or relevancy of search results in the transcript database.

The SSMD model may then be served, such as via an API, within a main application for inmate communication transcription and/or searching 110. API calls may, for example, be made by the application UI in any of a variety of ways to facilitate engagement with the SSMD model. This may, for example, allow users to receive real-time search recommendations as they type search terms and/or phrases. A determination may then be made as to whether to collect user feedback (e.g., for relevance) and use that data to fine tune the SSMD model further for more accuracy 115. If so, such feedback is collected and fed back to the SSMD model to adjust model parameters and/or facilitate model re-training 120. Otherwise, the SSMD process concludes 125.

Further detail for processes of transcript preparation and processing 101 is shown, in one implementation, in FIG. 2. Transcriptions of all relevant inmate communications, such as telephone calls, e-mail, chat, text, social media posts, and/or the like, may be collected 201. Transcribed communications may then be tokenized 205, such as by breaking down transcribed text into individual words and/or phrases. A determination may be made as to whether a particular collection of transcribed text includes so-called stop words (e.g., “and,” “the,” “is,” and/or the like) which do not contribute significant meaning. If so, these may be removed from further processing 215. The SSMD may then create word embeddings 220, such as by converting identified words and/or phrases into numerical vectors. Vectorized words and/or phrases may then be mapped into a multidimensional vector space 225, such as to facilitate the determination of similarity.

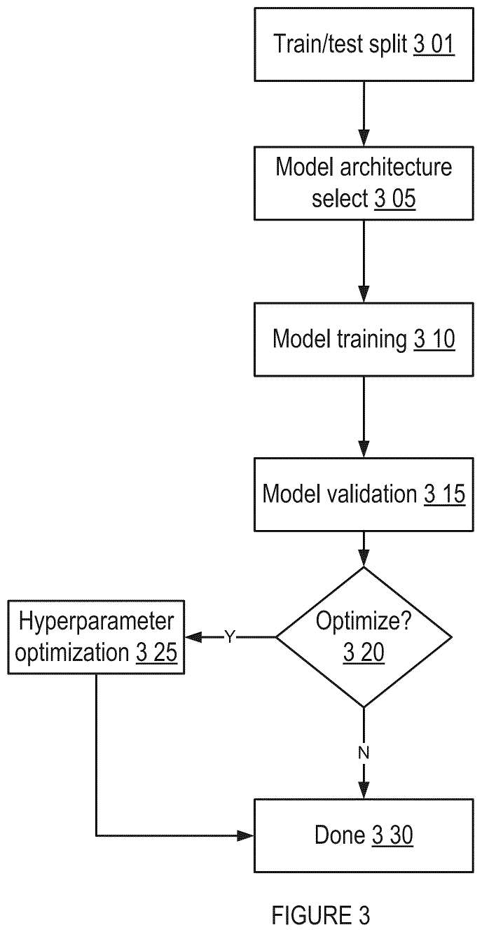

Further detail for processes of SSMD model training 105 is shown, in one implementation, in FIG. 3. The dataset, such as transcribed and vectorized inmate communications, may be divided into training and testing subsets 301. A model architecture may then be selected, such as including the structure and type of machine learning model (e.g., artificial neural network, regression system, classification system, clustering system, decision tree, support vector machine, and/or the like). The model may then be trained 310, such as by using the training data identified at 301. A validation process may be undertaken 315, such as to test the model's performance on the testing data identified at 301. A determination May then be made as to whether to optimize the model 320. If so, model parameters, hyperparameters, and/or the like may be adjusted to improve performance 325. Otherwise, the training process concludes 330.

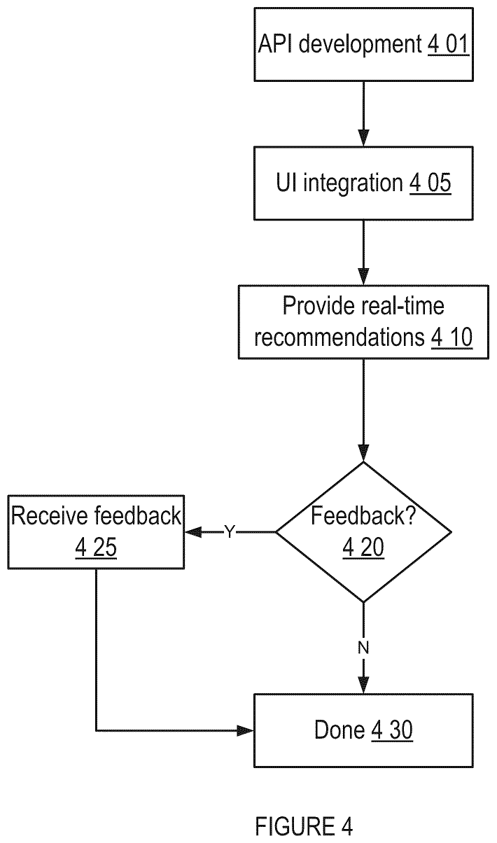

Further detail for application integration of SSMD model training 110 is shown, in one implementation, in FIG. 4. An application programming interface (API) may be created for an application to interact with the trained model 401. Using the API, the model's features and functionality may be integrated into the application's user interface 405. This may then facilitate the provision of real-time recommendations, suggestions, and/or the like to users as they type in search terms and/or phrases 410. A determination may be made as to whether to provide feedback for model improvement 420. If so, a user may be provided with options to provide feedback on recommendations (e.g., to assess accuracy, provide suggestions, and/or the like) 425, which may then be employed to further refine the model. The SSMD integration process may then conclude 430.

### User Interface

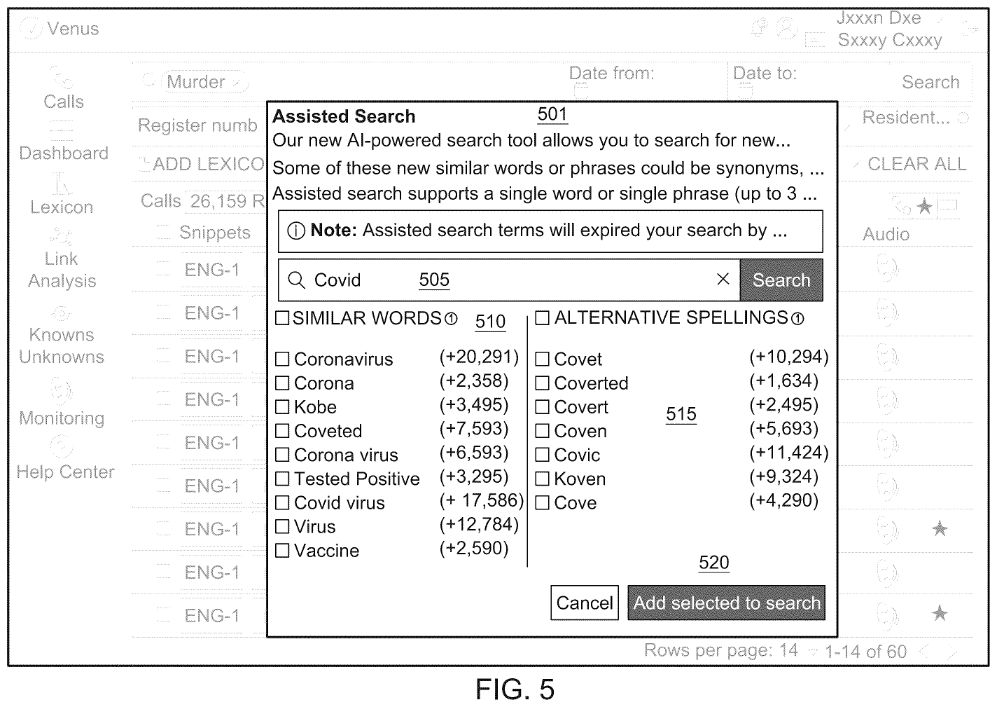

An example of user interface for assisted search employing SSMD features is shown in FIG. 5. Upon performing a search, a user may be presented with a pop-up window 501, which may include a search field 505 that is auto-populated by a particular search word and/or phrase, or otherwise that is manually entered by a user. In response, the window may provide selectable lists of similar words and/or phrases 510 and/or alternative spellings 515. The user may then be provided with a button 520 allowing one or more selected items of similar words and/or alternative spellings to be included in the original search being performed.

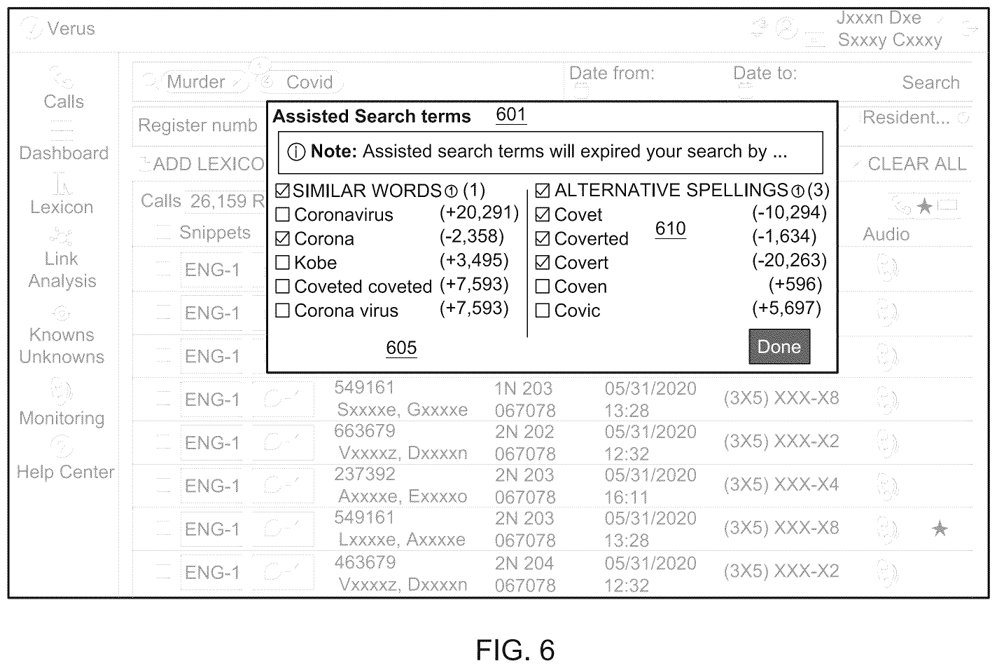

Another example of user interface for assisted search employing SSMD features is shown in FIG. 6. In this implementation, a user may select a search term, such as by clicking or scrolling over the term, to be presented with a search chip window 601. The window may include selectable lists of similar words 605 and/or alternative spellings 610, allowing the user to select terms of interest that will be included in the original search being performed.

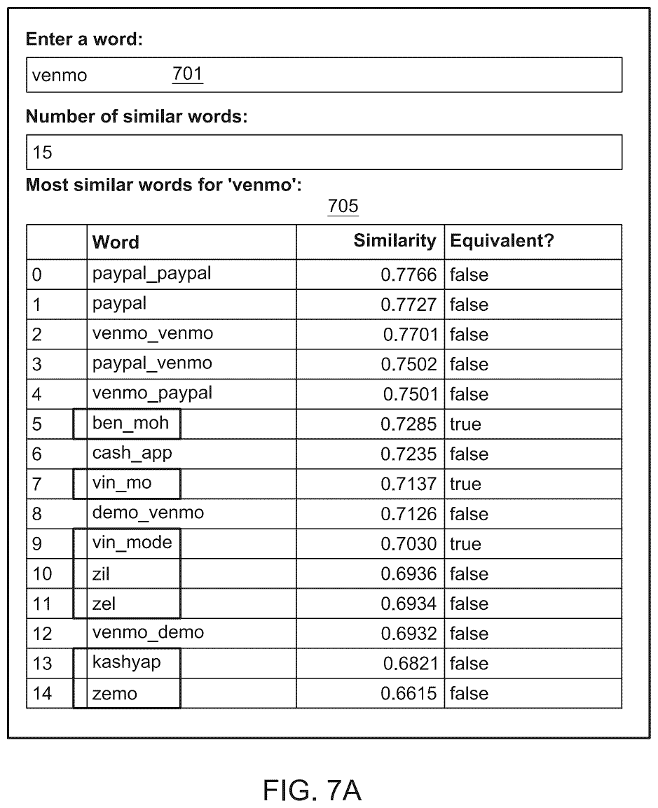

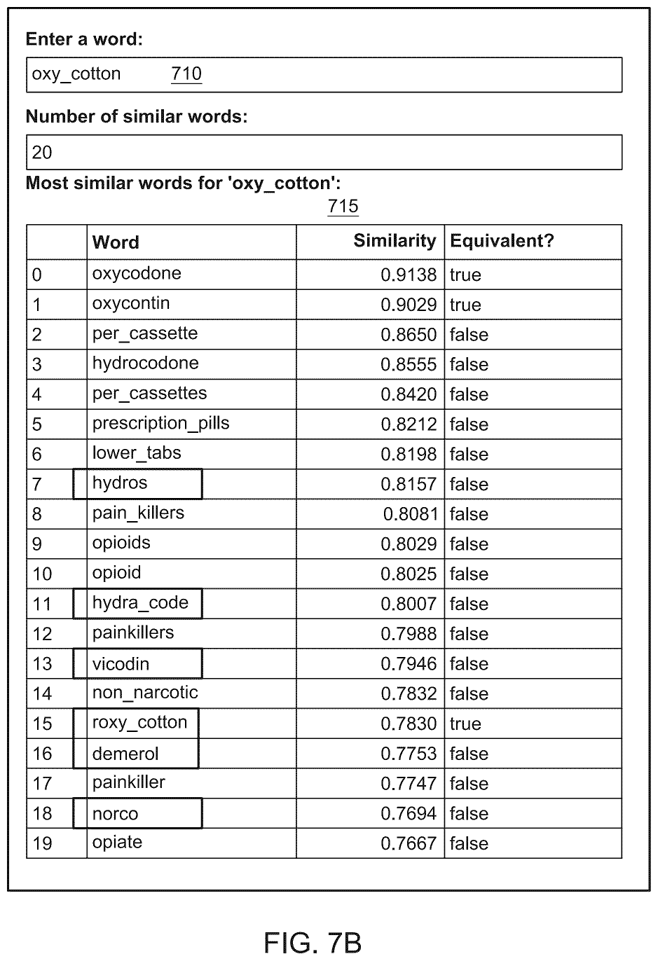

FIGS. 7A and 7B further illustrate word embedding search results, highlighting the advantages of the SSMD for identifying and surfacing possible mistranscriptions and synonyms that may otherwise be missed searching only for the root word. In FIG. 7A, a root word “Venmo™,” provided in a search field 701, may surface a collection of other similar words 705, including other payment systems (e.g., CashApp™, Zelle™) as well as various mistranscriptions. Note, where a suggested word is identified as a possible mistranscription for the root word, the SSMD may, in various implementations, identify its “Equivalent” value as “true,” facilitating the separation of “similar words” and “alternative spellings” for the root word, such as for presentation as such in a user interface. In FIG. 7B, a term “oxy_cotton” in search field 710 may comprise a mistranscribed word for OxyContin™, which is a brand name for an opioid oxycodone. The term produces a listing of other synonyms, slang terms, alternate brand names, and/or the like for this opioid.

### FURTHER EMBODIMENTS

In one further embodiment of the SSMD, multiple words and/or phrases may be input simultaneously to generate a visual representation of their contextual connections. This may, for example, facilitate a user's ability to grasp relationships and semantic similarities between multiple terms and their associated suggestions. This may, for example, allow a user to grasp relationships and/or semantic similarities between multiple terms and their associated suggestions.

In one implementation, results may be displayed as a dynamic, interactive word cloud. The proximity of words in the cloud may, for example, be representative of their semantic similarity, with closely related terms positioned nearer to each other. Some implementations of the SSMD may utilize one or more graphical visualization user interface toolkits, such as Cambridge Intelligence's ReGraph™ UI Toolkit which utilizes KeyLines javascript library in conjunction with a React component. In other implementations, different graphical visualization user interface toolkits may be employed, such as but not limited to Cytoscape.js™, Graphviz™, Kumu.io™, and/or the like. The SSMD may implement a backend application programming interface (API) to interact with and/or utilize features of the toolkit. The API may include, for example, a Graph Database, an ElasticSearch Graph API, an ElasticSearch API, and/or the like. In addition to providing an intuitive illustration of semantic relationships between words, this may also allow for the identification of overarching themes, commonalities, and/or the like between different input terms. Such a visualization term may facilitate the exploration and understanding of complex language patterns within inmate communications. For example, it may allow users to inspect interconnections between terms, providing a broader picture of the semantic landscape and facilitating the revelation of potentially coded language or hidden meanings.

In another embodiment, the SSMD may provide for a dynamic inmate lexicon update system. Such a feature may be configured, for example, to continually evolve and enrich the existing lexicons stored in an SSMD database, thus keeping up with ever-changing language patterns, slang terms, and/or the like within inmate communications.

In one implementation, the SSMD may apply the word embedding model to newly transcribed calls to identify novel terms, phrases, corresponding synonyms, slangs, and/or the like. Such a Super Subject Matter Expert (SSME) implementation operates like a linguist with a deep and current understanding of inmate communication lexicons.

In one implementation, newly discovered terms are added automatically to the SSMD system lexicons. In one implementation, an option for manual review and approval of new terms is provided, for improved accuracy and control.

### SSMD Controller

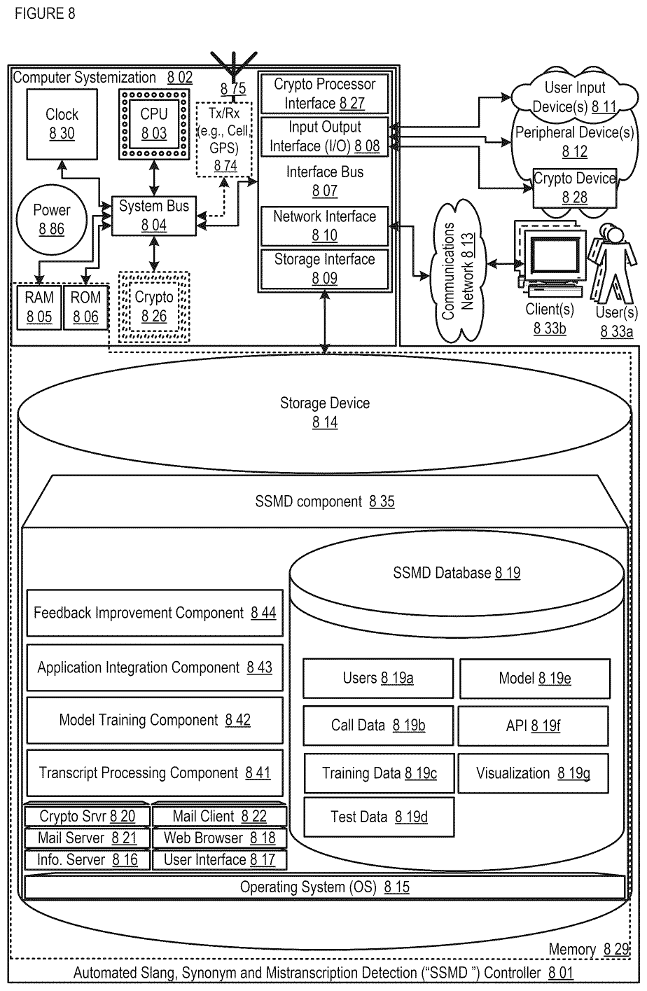

FIG. 8 illustrates inventive aspects of a SSMD controller 801 in a block diagram. In this embodiment, the SSMD controller 801 may serve to aggregate, process, store, search, serve, identify, instruct, generate, match, and/or facilitate interactions with a computer through various technologies, and/or other related data.

Typically, users, e.g., 833a, which may be people and/or other systems, may engage information technology systems (e.g., computers) to facilitate information processing. In turn, computers employ processors to process information; such processors 803 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 829 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the SSMD controller 801 may be connected to and/or communicate with entities such as, but not limited to: one or more users from user input devices 811; peripheral devices 812; an optional cryptographic processor device 828; and/or a communications network 813. For example, the SSMD controller 801 may be connected to and/or communicate with users, e.g., 833a, operating client device(s), e.g., 833b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The SSMD controller 801 may be based on computer systems that may comprise, but are not limited to, components such as: a computer systemization 802 connected to memory 829.

### Computer Systemization

A computer systemization 802 may comprise a clock 830, central processing unit (“CPU(s)” and/or “processor(s)” (these terms are used interchangeable throughout the disclosure unless noted to the contrary)) 803, a memory 829 (e.g., a read only memory (ROM) 806, a random access memory (RAM) 805, etc.), and/or an interface bus 807, and most frequently, although not necessarily, are all interconnected and/or communicating through a system bus 804 on one or more (mother) board(s) 802 having conductive and/or otherwise transportive circuit pathways through which instructions (e.g., binary encoded signals) May travel to effect communications, operations, storage, etc. Optionally, the computer systemization may be connected to an internal power source 886; e.g., optionally the power source may be internal. Optionally, a cryptographic processor 826 and/or transceivers (e.g., ICs) 874 may be connected to the system bus. In another embodiment, the cryptographic processor and/or transceivers may be connected as either internal and/or external peripheral devices 812 via the interface bus I/O. In turn, the transceivers may be connected to antenna(s) 875, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing SSMD controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 829 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the SSMD controller and beyond through various interfaces. Should processing requirements dictate a greater amount speed and/or capacity, distributed processors (e.g., Distributed SSMD), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the SSMD may be achieved by implementing a microcontroller such as CAST's R8051XC2 microcontroller; Intel's MCS 51 (i.e., 8051 microcontroller); and/or the like. Also, to implement certain features of the SSMD, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the SSMD component collection (distributed or otherwise) and/or features may be implemented via the microprocessor and/or via embedded components; e.g., via ASIC, coprocessor, DSP, FPGA, and/or the like. Alternately, some implementations of the SSMD may be implemented with embedded components that are configured and used to achieve a variety of features or signal processing.

Depending on the particular implementation, the embedded components may include software solutions, hardware solutions, and/or some combination of both hardware/software solutions. For example, SSMD features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the SSMD features. A hierarchy of programmable interconnects allow logic blocks to be interconnected as needed by the SSMD system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the SSMD may be developed on regular FPGAs and then migrated into a fixed version that more resembles ASIC implementations. Alternate or coordinating implementations May migrate SSMD controller features to a final ASIC instead of or in addition to FPGAs. Depending on the implementation all of the aforementioned embedded components and microprocessors may be considered the “CPU” and/or “processor” for the SSMD.

### Power Source

The power source 886 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 886 is connected to at least one of the interconnected subsequent components of the SSMD thereby providing an electric current to all subsequent components. In one example, the power source is connected to the system bus component 804. In an alternative embodiment, an outside power source 886 is provided through a connection across the I/O 808 interface. For example, a USB and/or IEEE 1394 connection carries both data and power across the connection and is therefore a suitable source of power.

### Interface Adapters

Interface bus(ses) 807 may accept, connect, and/or communicate to a number of interface adapters, conventionally although not necessarily in the form of adapter cards, such as but not limited to: input output interfaces (I/O) 808, storage interfaces 809, network interfaces 810, and/or the like. Optionally, cryptographic processor interfaces 827 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E) ISA), Micro Channel Architecture (MCA), NuBus, Peripheral Component Interconnect (Extended) (PCI (X)), PCI Express, Personal Computer Memory Card International Association (PCMCIA), and/or the like.

Storage interfaces 809 may accept, communicate, and/or connect to a number of storage devices such as, but not limited to: storage devices 814, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 810 may accept, communicate, and/or connect to a communications network 813. Through a communications network 813, the SSMD controller is accessible through remote clients 833b (e.g., computers with web browsers) by users 833a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed SSMD), architectures may similarly be employed to pool, load balance, and/or otherwise increase the communicative bandwidth required by the SSMD controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 810 may be used to engage with various communications network types 813. For example, multiple network interfaces may be employed to allow for the communication over broadcast, multicast, and/or unicast networks.

Input Output interfaces (I/O) 808 may accept, communicate, and/or connect to user input devices 811, peripheral devices 812, cryptographic processor devices 828, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 811 often are a type of peripheral device 812 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 812 may be connected and/or communicate to I/O and/or other facilities of the like such as network interfaces, storage interfaces, directly to the interface bus, system bus, the CPU, and/or the like. Peripheral devices may be external, internal and/or part of the SSMD controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 828), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the SSMD controller may be embodied as an embedded, dedicated, and/or monitor-less (i.e., headless) device, wherein access would be provided over a network interface connection.

Cryptographic units such as, but not limited to, microcontrollers, processors 826, interfaces 827, and/or devices 828 may be attached, and/or communicate with the SSMD controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 829. However, memory is a fungible technology and resource, thus, any number of memory embodiments may be employed in lieu of or in concert with one another. It is to be understood that the SSMD controller and/or a computer systemization may employ various forms of memory 829. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 829 will include ROM 806, RAM 805, and a storage device 814. A storage device 814 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 829 may contain a collection of program and/or database components and/or data such as, but not limited to: operating system component(s) 815 (operating system); information server component(s) 816 (information server); user interface component(s) 817 (user interface); Web browser component(s) 818 (Web browser); database(s) 819; mail server component(s) 821; mail client component(s) 822; cryptographic server component(s) 820 (cryptographic server); the SSMD component(s) 835; and/or the like (i.e., collectively a component collection). These components may be stored and accessed from the storage devices and/or from storage devices accessible through an interface bus. Although non-conventional program components such as those in the component collection, typically, are stored in a local storage device 814, they may also be loaded and/or stored in memory such as: peripheral devices, RAM, remote storage facilities through a communications network, ROM, various forms of memory, and/or the like.

### Operating System

The operating system component 815 is an executable program component facilitating the operation of the SSMD controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the SSMD controller to communicate with other entities through a communications network 813. Various communication protocols may be used by the SSMD controller as a subcarrier transport mechanism for interaction, such as, but not limited to: multicast, TCP/IP, UDP, unicast, and/or the like.

### Information Server

An information server component 816 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the SSMD controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the SSMD database 819, operating systems, other program components, user interfaces, Web browsers, and/or the like.

Access to the SSMD database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the SSMD. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the SSMD as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D) HTML, FLASH, Java, JavaScript, etc. interface libraries such as, but not limited to, Dojo, jQuery (UI), MooTools, Prototype, script.aculo.us, SWFObject, Yahoo! User Interface, any of which May be used and) provide a baseline and means of accessing and displaying information graphically to users.

A user interface component 817 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 818 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D) HTML, FLASH, Java, JavaScript, web browser plug-in APIs (e.g., FireFox, Safari Plug-in, and/or the like APIs), and/or the like. Web browsers and like information access tools May be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the SSMD enabled nodes. The combined application may be nugatory on systems employing standard Web browsers.

### Mail Server

A mail server component 821 is a stored program component that is executed by a CPU 803. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the SSMD.

Access to the SSMD mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 822 is a stored program component that is executed by a CPU 803. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 820 is a stored program component that is executed by a CPU 803, cryptographic processor 826, cryptographic processor interface 827, cryptographic processor device 828, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component May employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the SSMD may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component May communicate to and/or with other components in a component collection, including itself, and/or facilities of the like. The cryptographic component supports encryption schemes allowing for the secure transmission of information across a communications network to enable the SSMD component to engage in secure transactions if so desired. The cryptographic component facilitates the secure accessing of resources on the SSMD and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The SSMD Database

The SSMD database component 819 may be embodied in a database and its stored data. The database is a stored program component, which is executed by the CPU; the stored program component portion configuring the CPU to process the stored data. The database May be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the SSMD database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the SSMD database is implemented as a data-structure, the use of the SSMD database 819 may be integrated into another component such as the SSMD component 835. Also, the database May be implemented as a mix of data structures, objects, and relational structures. Databases May be consolidated and/or distributed in countless variations through standard data processing techniques. Portions of databases, e.g., tables, may be exported and/or imported and thus decentralized and/or integrated.

In one embodiment, the database component 819 includes several tables 819a-d. A User table 819a may include fields such as, but not limited to: user_ID, name, login, password, contact_info, query_history, settings, preferences, and/or the like. The User table may support and/or track multiple entity accounts on a SSMD. A Call Data table 819b May include fields such as, but not limited to: call_data_ID, call_ID, caller_ID, caller_name, caller_status, caller_telephone, site_ID, station, area_code, call_transcript, call_metadata, and/or the like. A Training Data table 819c may include fields such as, but not limited to: training_data_ID, call_data_ID, call_ID, caller_ID, transcript_terms; call_metadata; and/or the like. A Test Data table 819d may include fields such as, but not limited to: test_data_ID, call_data_ID, call_ID, caller_ID, transcript_terms; call_metadata; and/or the like. A Model table 819e may include fields such as, but not limited to: model_ID; training_data_ID, test_data_ID; call_data_ID, call_ID, caller_ID, transcript_terms; synonyms; mistranscriptions; misspellings; slang_terms; and/or the like. An API table 819f may include fields such as, but not limited to: API_ID; model_ID; application; API_commands; and/or the like. A Visualization table 819g may include fields such as, but not limited to: graph_ID; graph_type; user_ID; call_data_ID; call_ID; caller_ID; model_ID; and/or the like.

In one embodiment, the SSMD database may interact with other database systems. For example, employing a distributed database system, queries and data access by search SSMD component may treat the combination of the SSMD database, an integrated data security layer database as a single database entity.

In one embodiment, user programs may contain various user interface primitives, which may serve to update the SSMD. Also, various accounts may require custom database tables depending upon the environments and the types of clients the SSMD may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 819a-d. The SSMD may be configured to keep track of various settings, inputs, and parameters via database controllers.

The SSMD database may communicate to and/or with other components in a component collection, including itself, and/or facilities of the like. Most frequently, the SSMD database communicates with the SSMD component, other program components, and/or the like. The database may contain, retain, and provide information regarding other nodes and data.

### The SSMDs

The SSMD component 835 is a stored program component that is executed by a CPU. In one embodiment, the SSMD component incorporates any and/or all combinations of the aspects of the SSMD discussed in the previous figures. As such, the SSMD affects accessing, obtaining and the provision of information, services, transactions, and/or the like across various communications networks. The features and embodiments of the SSMD discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the SSMD's features and facilities, and in many cases reduce the costs, energy consumption/requirements, and extend the life of SSMD's underlying infrastructure; this has the added benefit of making the SSMD more reliable. Similarly, many of the features and mechanisms are designed to be easier for users to use and access, thereby broadening the audience that may enjoy/employ and exploit the feature sets of the SSMD; such ease of use also helps to increase the reliability of the SSMD. In addition, the feature sets include heightened security as noted via the Cryptographic components 820, 826, 828 and throughout, making access to the features and data more reliable and secure.

The SSMD component transforms raw data, query, and, UI interaction inputs via SSMD transcript processing 841; model training 842; application integration 843; and feedback improvement 844 into semantic models; slang, synonym, mistranscription, and/or misspelling relationships; query result outputs; semantic graphs; user interface displays, and/or the like.

The SSMD component enabling access of information between nodes may be developed by employing standard development tools and languages such as, but not limited to: Apache components, Assembly, ActiveX, binary executables, (ANSI) (Objective-) C(++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D) HTML; Dojo, Java; JavaScript; jQuery (UI); MooTools; Prototype; script.aculo.us; Simple Object Access Protocol (SOAP); SWFObject; Yahoo! User Interface; and/or the like), WebObjects, and/or the like. In one embodiment, the SSMD server employs a cryptographic server to encrypt and decrypt communications. The SSMD component may communicate to and/or with other components in a component collection, including itself, and/or facilities of the like. Most frequently, the SSMD component communicates with the SSMD database, operating systems, other program components, and/or the like. The SSMD may contain, communicate, generate, obtain, and/or provide program component, system, user, and/or data communications, requests, and/or responses.

### Distributed SSMDs

The structure and/or operation of any of the SSMD node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the SSMD controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D) COM), (Distributed) Object Linking and Embedding ((D) OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1
where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the SSMD controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(′Content-Type: text/plain′);
// set ip address and port to listen to for incoming data
$address = ‘192.168.0.100’;
$port = 255;
// create a server-side SSL socket, listen for/accept incoming
  communication
$sock = socket_create(AF_INET, SOCK_STREAM, 0);
socket_bind($sock, $address, $port) or die(‘Could not bind to
  address');
socket_listen($sock);
$client = socket_accept($sock);
// read input data from client device in 1024 byte blocks until end of
  message
do {
  $input = “”;
  $input = socket_read($client, 1024);
  $data .= $input;
} while($input != “”);
// parse data to extract variables
$obj = json_decode($data, true);
// store input data in a database
mysql_connect(″201.408.185.132″,$DBserver,$password); // access
  database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm
.IBMDI.doc/referenceguide295.htm

and other parser implementations:

http://publib.boulder.ibm.com/infocenter/tivihelp/v2r1/index.jsp?topic=/com.ibm
.IBMDI.doc/referenceguide259.htm

all of which are hereby expressly incorporated by reference.

In order to address various issues and advance the art, the entirety of this application for AUTOMATED SLANG, SYNONYM AND MISTRANSCRIPTION DETECTION APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a SSMD individual and/or enterprise user, database configuration and/or relational model, data type, data transmission and/or network framework, syntax structure, and/or the like, various embodiments of the SSMD may be implemented that enable a great deal of flexibility and customization. For example, aspects of the SSMD may be adapted for analysis of call center communications, social media and/or other electronic publications, workplace communications, and/or the like. While various embodiments and discussions of the SSMD have been directed to efficient data collection, storage, and evaluation, however, it is to be understood that the embodiments described herein may be readily configured and/or customized for a wide variety of other applications and/or implementations.

What is claimed is:

1. A processor-implemented method, comprising:
integrating an inmate communications language model with at least one inmate communications search application via a model application programming interface; and
providing real-time lexicographic recommendations in response to at least one inmate communications search query, the real-time lexicographic recommendations comprising at least one of a synonym, slang term, mistranscription correction, and misspelling correction.

2. The method of claim 1, further comprising:
selecting a language model architecture for the inmate communications language model.

3. The method of claim 1, further comprising:
performing word embeddings to map a plurality of inmate communications tokens derived from a plurality of inmate communications transcripts to a corresponding plurality of inmate communication vectors; and
training the inmate communications model based on a subset of the plurality of inmate communication vectors.

4. The method of claim 3, further comprising:
splitting the plurality of inmate communications vectors into training vectors and test vectors; and
wherein the subset of the plurality of inmate communication vectors correspond to the training vectors.

5. The method of claim 4, further comprising:
validating the inmate communications language model with the testing vectors.

6. The method of claim 3, further comprising:
tokenizing a plurality of inmate communications transcripts to yield the plurality of inmate communications tokens.

7. The method of claim 6, further comprising:
removing stop words from the plurality of inmate communications tokens.

8. The method of claim 6, further comprising:
transcribing a plurality of inmate communications data to yield the plurality of inmate communications transcripts.

9. The method of claim 8, further comprising:
receiving the inmate communications data.

10. The method of claim 1, further comprising:
receiving recommendation feedback in response to the real-time lexicographic recommendations.

11. The method of claim 10, further comprising:
updating at least one inmate communications language model parameter based on the recommendation feedback.

12. The method of claim 1, further comprising:
providing an interactive word cloud via a user interface based on the inmate communications language model, wherein proximity of words in the interactive word cloud is based on a relationship between a corresponding plurality of inmate communication vectors in the inmate communications language model.

13. The method of claim 1, further comprising:
applying the inmate communications language model to newly transcribed inmate communications to identify novel terms;
updating the inmate communications language model based on the novel terms.

14. The method of claim 13, further comprising:
transcribing inmate communications data to yield the newly transcribed inmate communications.

15. The method of claim 14, further comprising:
receiving the inmate communications data.

16. An apparatus, comprising:
a processor;
a memory communicatively coupled to the processor and storing program instructions that, when executed, cause the processor to:
integrate an inmate communications language model with at least one inmate communications search application via a model application programming interface; and
provide real-time lexicographic recommendations in response to at least one inmate communications search query, the real-time lexicographic recommendations comprising at least one of a synonym, slang term, mistranscription correction, and misspelling correction.

17. A processor-accessible, non-transitory medium storing processor-issuable program instructions, comprising:
integrate an inmate communications language model with at least one inmate communications search application via a model application programming interface; and
provide real-time lexicographic recommendations in response to at least one inmate communications search query, the real-time lexicographic recommendations comprising at least one of a synonym, slang term, mistranscription correction, and misspelling correction.

18. A processor-implemented method, comprising:
receiving inmate communications data;
transcribing the inmate communications data to yield a plurality of inmate communication transcripts;
tokenizing the plurality of inmate communication transcripts to yield a plurality of inmate communications tokens;
removing stop words from the plurality of inmate communications tokens;
performing word embeddings to map the plurality of inmate communications tokens to a corresponding plurality of inmate communications vectors;
splitting the plurality of inmate communications vectors into training vectors and testing vectors;
selecting a language model architecture for an inmate communications language model;
training the inmate communications language model with the training vectors;
validating the inmate communications language model with the testing vectors;
integrating the inmate communications language model with at least one inmate communications search application via a model application programming interface;
providing real-time lexicographic recommendations in response to at least one inmate communications search query, the real-time lexicographic recommendations comprising at least one of a synonym, slang term, mistranscription correction, and misspelling correction;
receiving recommendation feedback in response to the real-time lexicographic recommendations; and
updating at least one inmate communications language model parameter based on the recommendation feedback.
